(19) United States
(12) Patent Application Publication
(10) Pub. No.: US 2009/0324185 A1
(43) Pub. Date: Dec. 31, 2009

(54) LIGHT GUIDE FOR ENDOSCOPES

(75) Inventor: Shinichi SHIMOTSU, Kanagawa-ken (JP)

Correspondence Address: Studebaker & Brackett PC, One Fountain Square, 11911 Freedom Drive, Suite 750, Reston, VA, 20190, US

(73) Assignee: FUJIFILM CORPORATION, Tokyo (JP)

(21) Appl. No.: 12/495,229

(22) Filed: Jun. 30, 2009

(30) Foreign Application Priority Data
Jun. 30, 2008 (JP) 171482/2008

(51) Int. Cl. G02B 6/06

(52) U.S. Cl. 385/117

(57) ABSTRACT

A light guide for endoscopes constituted by a plurality of bundled optical fibers is formed such that it is flexible at portions where flexibility is required, and such that the durability thereof is improved. The light guide for endoscopes is constituted by a plurality of bundled optical fibers, for propagating an illuminating light beam that enters from a light input end facet thereof to a light output end facet thereof, to emit the illuminating light beam onto a portion to be observed. The light guide includes: a plurality of comparatively large diameter optical fibers; and a plurality of comparatively small diameter optical fibers which are provided at the side of the light guide toward the light output end facet thereof. Each of the comparatively large diameter optical fibers is connected to a plurality of the comparatively small diameter optical fibers.

### BACKGROUND OF THE INVENTION

1. Field of the Invention

The present invention is related to a light guide for endoscopes, that is, a light guide that propagates light therethrough such that portions which are observed with an endoscope are illuminated.

2. Description of the Related Art

Conventionally, endoscopes are in wide use to observe and perform surgical procedures on portions within body cavities of humans. Flexible light guides for illuminating the observed portions of subjects are employed in these endoscopes. Note that in cases that surgical procedures are performed on portions, observation thereof is necessary. Therefore, portions on which surgical procedures are performed will also be referred to as “observed portions” in the present specification.

At least a portion of this type of light guide is generally constituted by a plurality of thin multi mode optical fibers which are bundled, to impart flexibility thereto. Japanese Unexamined Patent Publication No. H6(1994)-296584 discloses an example of a light guide for endoscopes configured in this manner. This light guide for endoscopes receives illuminating light beam, by the illuminating light beam being emitted from an illuminating light source, focused, then irradiated on a first end facet of the light guide. The illuminating light beam propagates through the light guide and is emitted from a second end facet to illuminate an observed portion.

An example of a conventional light guide for endoscopes 5 is illustrated in FIG. 7. In FIG. 7, reference numeral 11 denotes a plurality of multi mode optical fibers, and reference numeral 12 denotes a filling adhesive for fixing the multi mode optical fibers 11 in a bundle so as to form a connector portion. Note that the filling adhesive 12 is generally housed within a cylindrical connector housing. Reference numeral 6 of FIG. 7 denotes an illuminating light source for emitting an illuminating light beam 7, reference numeral 8 denotes a focusing optical system for focusing the illuminating light beam 7 and causing it to enter the plurality of multi mode optical fibers 11 from a side towards first end facets (light input end facets) thereof, and reference numeral 9 denotes an optical element which is provided in close contact with the second end facets (light output end facets) of the multi mode optical fibers 11.

In light guides for endoscopes which are constituted by a plurality of bundled optical fibers, there is demand for the tips of the light guides and the vicinities thereof to be flexible with small radii of curvature, in order to obtain favorable observation properties and operability within body cavities. In order to meet this demand, smaller diameter optical fibers may be employed. However, in this case, the optical fibers become easily breakable at the base portions (the ends at which illuminating light enters) thereof, at which flexibility is not desired. This causes a problem that the durability of the light guides deteriorates.

### SUMMARY OF THE INVENTION

The present invention has been developed in view of the foregoing circumstances. It is an object of the present invention to provide a light guide for endoscopes which it is flexible at portions where flexibility is required, and which is superior in durability.

A light guide for endoscopes of the present invention is constituted by a plurality of bundled optical fibers, for propagating an illuminating light beam that enters from a light input end facet thereof to a light output end facet thereof, to emit the illuminating light beam onto a portion to be observed. The light guide comprises: a plurality of comparatively large diameter optical fibers; and a plurality of comparatively small diameter optical fibers which are provided at the side of the light guide toward the light output end facet thereof. The light guide for endoscopes of the present invention is characterized by each of the comparatively large diameter optical fibers being connected to a plurality of the comparatively small diameter optical fibers.

Note that it is desirable for the plurality of comparatively small diameter optical fibers to be connected to each of the comparatively large diameter optical fibers in a maximally densely packed state.

In this case, specifically, it is desirable for a central optical fiber and six peripheral optical fibers which are arranged about the periphery of the central optical fiber to be employed as the comparatively small diameter optical fibers; and for the optical fibers to form the maximally densely packed state by being provided such that each of the six peripheral optical fibers is in contact with the central optical fiber, and adjacent peripheral optical fibers are in contact with each other.

It is also desirable for the light guide for endoscopes of the present invention to further comprise: a transparent member having a sectional shape which is at least as large as the focused spot of the illuminating light beam, provided in close contact with the light input end facets of the comparatively large diameter optical fibers; and for the comparatively large optical fibers to be in contact with the transparent member in a maximally densely packed state.

A glass rod may be favorably employed as the transparent member, for example.

In the case that the transparent member is provided, it is desirable for a central optical fiber and six peripheral optical fibers which are arranged about the periphery of the central optical fiber are employed as the optical fibers which are connected to the transparent member; and for the optical fibers to form the maximally densely packed state by being provided such that each of the six peripheral optical fibers is in contact with the central optical fiber, and adjacent peripheral optical fibers are in contact with each other.

Further, it is desirable for multi mode optical fibers to be employed as the optical fibers; and for at least one of a light input portion, at which the illuminating light enters the optical fibers, and the light output portion, from which the illuminating light is output, to be of a tapered shape, while the number of multi mode optical fibers at the light input portion and the number of multi mode optical fibers at the light output portion are the same as that at other portions of the light guide.

It is also desirable for the light guide for endoscopes of the present invention to further comprise: a concave transparent member, which is provided in close contact with the light output end facet.

In light guides for endoscopes, the portions at which flexibility is desired are the tips at the light output ends thereof, including a certain distance from the tips inward. In contrast, the base portions, into which illuminating light beams enter, are generally housed and fixed within the main bodies of endoscopes, and therefore, flexibility is not required at these portions. In view of these points, the light guide for endoscopes employs the plurality of comparatively large diameter optical fibers and the plurality of comparatively small diameter optical fibers, which are connected to each other. The former are provided at the end where the illuminating light beam enters, and the latter are provided at the end where the illuminating light beam is output. Accordingly, favorable flexibility is realized at the portion in the vicinity of the light output tip, at which flexibility is desired, and high structural strength is secured at the base portion, at which flexibility is not particularly required.

Note that a configuration may be adopted, wherein the plurality of comparatively small diameter optical fibers are connected to each of the comparatively large diameter optical fibers in a maximally densely packed state. In this case, heat generation at the portions among the comparatively small diameter optical fibers can be suppressed. That is, in this case, the spaces among the comparatively small diameter optical fibers become smaller. Therefore, absorption of the illuminating light beam by filing adhesive and the like positioned within these spaces is reduced, and heat generation due to absorption of the illuminating light beam is suppressed.

A configuration may be adopted, wherein a central optical fiber and six peripheral optical fibers which are arranged about the periphery of the central optical fiber are employed as the comparatively small diameter optical fibers; and the optical fibers form the maximally densely packed state by being provided such that each of the six peripheral optical fibers is in contact with the central optical fiber, and adjacent peripheral optical fibers are in contact with each other. In this case, heat generation at the light input portion of the optical fibers, which is likely to occur, can also be suppressed. This point will be described in detail below.

According to investigations conducted by the present inventor, heat generation is likely to occur at the light input portions of conventional light guides for endoscopes, which are constituted by pluralities of bundled optical fibers. The two factors described below are the cause of the heat generation. These factors will be described in detail with reference to FIG. 8.

FIG. 8 is a sectional view that schematically illustrates the light input portion of the conventional light guide for endoscopes of FIG. 7. As illustrated in FIG. 8, some of the plurality of optical fibers 11, which are fixed by the filling adhesive 12 in a bundled state, are far apart from each other, and portions of some of the optical fibers 11 are exposed outside the outer periphery of the filling adhesive 12. In the case that the plurality of optical fibers 11 are far apart from each other, the filling adhesive 12 is present in the spaces therebetween. Accordingly, an illuminating light beam which is emitted onto these spaces does not enter any optical fibers 11, but only serves to heat the filling adhesive 12. This is the aforementioned first factor that causes heat generation to occur.

As described previously, the filling adhesive 12 is generally contained within a cylindrical connector housing. Commonly, the illuminating light beam 7 is focused such that the focused spot diameter matches the outer periphery of the circle formed by the filling adhesive 12. The focused spot diameter is defined as 1/e² (the diameter at the portion where the light intensity becomes 1/e² of that at the center of the beam), and weak portions of the illuminating light beam 7 are emitted outside the focused spot diameter as well. For this reason, in the case that portions of the optical fibers 11 are exposed outside the outer periphery of the filling adhesive 12 as illustrated in FIG. 8, the weak portions of the illuminating light beam 7 does not efficiently enter these optical fibers 11, but rather is emitted onto and heats the end facets thereof. This is the aforementioned second factor that causes heat generation to occur.

In the light guide for endoscopes of the present invention, the transparent member having a sectional shape which is at least as large as the focused spot of the illuminating light beam may be provided in close contact with the light input end facets of the comparatively large diameter optical fibers. In this case, heat generation at the optical fibers due to the second factor described above can be prevented. In addition, the comparatively large optical fibers may be in contact with the transparent member in a maximally densely packed state. In this case, heat generation at the optical fibers due to the first factor described above can be prevented. By suppressing heat generation at the light input portions of the optical fibers in this manner, deterioration of the light input portions due to heat can be prevented.

In the light guide for endoscopes of the present invention, multi mode optical fibers may be employed as the optical fibers; and at least one of a light input portion, at which the illuminating light enters the optical fibers, and the light output portion, from which the illuminating light is output, are of a tapered shape, while the number of multi mode optical fibers at the light input portion and the number of multi mode optical fibers at the light output portion are the same as that at other portions of the light guide. In this case, the following advantageous effects can be obtained.

In multi mode fibers, there is a relationship that the product of the beam diameter (core diameter) of an input or output light beam and the angle of beam spread θ is maintained. Note that the numerical apertures of optical fibers are defined as NA=sin θ. In the light guide for endoscopes of the present invention, at least one of the light input portion and the light output portion, which are constituted by a plurality of bundled multi mode optical fibers, is of a tapered shape, while having the same number of optical fibers as at other portions of the light guide. Therefore, the core diameter at the light input portion and/or the light output portion is smaller than that of the other portions.

Based on the aforementioned relationship, the angle of beam spread θ at the light input portion and/or the light output portion will become greater, that is, the numerical aperture will become greater. Therefore, the illuminating light beam will enter the light input portion with greater light utilization efficiency, and wider areas of observed portions can be illuminated at the light output portion. FIG. 9A and FIG. 9B are diagrams for facilitating understanding of this phenomenon. In FIG. 9A and FIG. 9B, reference numeral 11 denotes a multi mode optical fiber, and reference numeral 11T denotes the core of the multi mode optical fiber 11. FIG. 9A illustrates a case in which no taper is provided, and FIG. 9B illustrates a case in which the multi mode optical fiber 11 is tapered. Here, a case is illustrated in which there is only one optical fiber. However, the principle applies in cases that a plurality of optical fibers are bundled.

In addition, by forming the light input portion and/or the light output portion into tapered shapes, these portions become resistant to damage. This point will be described in detail below. FIG. 10 is a diagram that schematically illustrates the cross section of an end portion of a conventional light guide for endoscopes that functions as a light input portion or a light output portion. As illustrated in FIG. 10, a plurality of multi mode optical fibers 11 are bundled and fixed by a filling adhesive 12 at the end portion. The end portion is housed within a cylindrical connector housing, for example. According to investigations conducted by the present inventor, it was found that it is difficult to arrange the plurality of multi mode optical fibers 11 into a maximally densely packed structure. That is, as illustrated in FIG. 10, it was unavoidable for the filling adhesive 12 to be present within the spaces among the multi mode optical fibers 11. For this reason, when the properties of the filling adhesive 12 deteriorate over time, the entirety of the end portion of the light guide becomes prone to damage.

In contrast, at least one end portion of the light guide for endoscopes of the present invention, that is, the light input portion and/or the light output portion, is tapered, while having the same number of optical fibers as the other portions thereof. In this case, the plurality of multi mode optical fibers 11 become a maximally densely packed structure or approaches a maximally densely packed structure, and the filling adhesive 12 is not present among the optical fibers, or only a small amount of the filling adhesive 12 is present among the optical fibers. Therefore, the end portion of the light guide, that is, the light input portion and/or the light output portion, becoming prone to damage due to deterioration of the filling adhesive 12 can be prevented.

The light guide for endoscopes of the present invention may further comprise a concave transparent member, which is provided in close contact with the light output end facet that functions as a light output surface of the illuminating light beam. In this case, the illuminating light beam which is output from the second end facet is diffused by the effect of the concave shape of the transparent member. Accordingly, an advantageous effect that the illuminated range can become even wider is obtained.

### BRIEF DESCRIPTION OF THE DRAWINGS

FIG. 1 is a side view that illustrates a light guide for endoscopes according to a first embodiment of the present invention.

FIG. 2 is a sectional diagram that illustrates a portion of the light guide for endoscopes of FIG. 1.

FIG. 3 is a sectional diagram that illustrates another portion of the light guide for endoscopes of FIG. 1.

FIG. 4 is a side view that illustrates a light guide for endoscopes according to a second embodiment of the present invention.

FIGS. 5A, 5B, and 5C are diagrams for explaining a method for producing the light guide for endoscopes of FIG. 4.

FIG. 6 is a side view that illustrates a light guide for endoscopes according to a third embodiment of the present invention.

FIG. 7 is a sectional side view of a conventional light guide for endoscopes.

FIG. 8 is a sectional view that illustrates a portion of the conventional light guide for endoscopes of FIG. 7.

FIG. 9A and FIG. 9B are diagrams for explaining the advantageous effects of the present invention.

FIG. 10 is a sectional view that illustrates a portion of a conventional light guide for endoscopes.

FIG. 11 is a side view that schematically illustrates a system for evaluating light guides for endoscopes.

### DESCRIPTION OF THE PREFERRED EMBODIMENTS

Hereinafter, embodiments of the present invention will be described in detail with reference to the attached drawings.

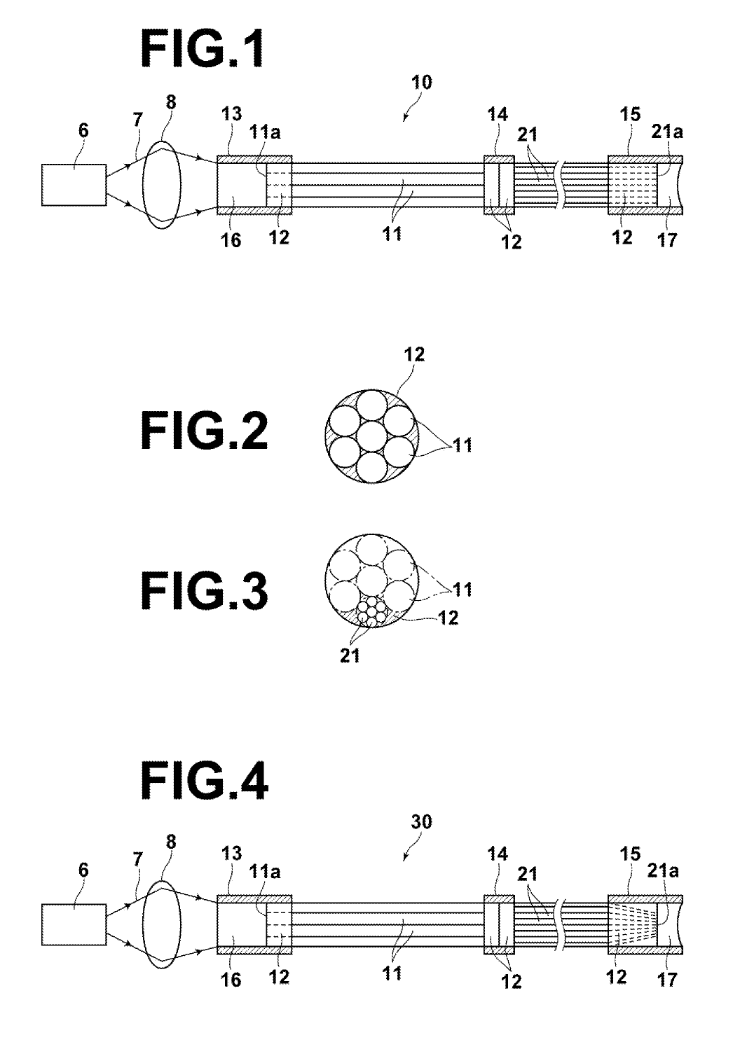

FIG. 1 is a side view that illustrates a light guide 10 for endoscopes according to a first embodiment of the present invention. The light guide 10 for endoscopes is constituted by a plurality of bundled multi mode optical fibers 11 having comparatively large diameters, and a plurality of bundled multi mode optical fibers 21 having comparatively small diameters, connected to the multi mode optical fibers 11. A first end portion of the bundled multi mode optical fibers 11 (the left end portion in FIG. 1) and a second end portion of the bundled multi mode optical fibers 11 (the right end portion in FIG. 1) are housed in cylindrical connector housings 13 and 14, respectively, and fixed therein by filling adhesive 12. Similarly, a first end portion of the multi mode optical fibers 21 (the left end portion in FIG. 1) and a second end portion of the multi mode optical fibers 21 (the right end portion in FIG. 1) are housed in cylindrical connector housings 14 and 15, respectively, and fixed therein by filling adhesive. The light output end facets of the multi mode optical fibers 11 and the light input end facets of the multi mode optical fibers 21 are provided in close contact with each other within the central connector housing 14, thereby optically connecting the optical fibers 11 and the optical fibers 12.

A glass rod 16, which is a cylindrical transparent member, is provided in close contact with the light input end facets 11a of the multi mode optical fibers 11. The surface of the glass rod 16, which is formed by optical glass, and the surfaces of the multi mode optical fibers 11 that contact the glass rod 16 are optically polished then caused to abut each other, to be optically connected by so called optical contact. Meanwhile, a transparent member 17 having a concave shape is provided in close contact with the light output end facets 21a of the multi mode optical fibers 21.

Note that multi mode optical fibers having cladding diameters of 250 μm and core diameters of 230 μm are employed as the multi mode optical fibers 11, for example. Multi mode optical fibers having cladding diameters of 80 μm and core diameters of 60 μm are employed as the multi mode optical fibers 21, for example. A transparent member having an outer diameter of 6.5 mm and a length of 10 mm is employed as the glass rod 16.

Here, the state of connection between the glass rod 16 and the multi mode optical fibers 11 will be described with reference to FIG. 2. FIG. 2 is a front view of the multi mode optical fibers 11 at the portion where they connect with the glass rod 16. As illustrated in FIG. 2, seven multi mode optical fibers 11 are employed here, and six peripheral optical fibers 11 are provided around a central optical fiber 11. Each of the six peripheral optical fibers 11 is in contact with the single central optical fiber 11, and adjacent peripheral optical fibers 11 are in contact with each other. Meanwhile, the glass rod 16 is of an outer diameter that fits tightly within the cylindrical connector housing 13 that contains the filling adhesive 12. That is, the outer diameter of the glass rod 16 is equal to the outer diameter of the filling adhesive 12 (which is the inner diameter of the connector housing 13 with which the six peripheral multi mode optical fibers 11 are in contact). Therefore, the seven multi mode optical fibers 11 are connected to the glass rod 16 in a maximally densely packed state.

Next, the state of connection among the plurality of multi mode optical fibers 11 and the plurality of multi mode optical fibers 21 will be described with reference to FIG. 3. FIG. 3 is a sectional view of the multi mode optical fibers 11 and the multi mode optical fibers 21 at the portion where they connect with each other. As illustrated in FIG. 3, seven multi mode optical fibers 21 are connected to each of the multi mode optical fibers 11, that is, a total of 49 multi mode optical fibers 21 are employed. Each group of seven multi mode optical fibers 21 are configured such that six peripheral optical fibers 21 are provided around a central optical fiber 21. Each of the six peripheral optical fibers 21 is in contact with the single central optical fiber 21, and adjacent peripheral optical fibers 21 are in contact with each other. Therefore, each group of seven multi mode optical fibers 21 is connected to each of the multi mode optical fibers 11 in a maximally densely packed state.

The light guide for endoscopes 10 having the construction described above is utilized in the same basic manner as the conventional light guide for endoscopes illustrated in FIG. 7. That is, the illuminating light beam 7 is emitted from the illuminating light source 6, focused by the focusing optical system 8, and is irradiated onto the end facet of the glass rod 16 in a focused state. Note that the outer diameter of the glass rod (6.5 mm) is equal to or greater than the focused spot diameter (1/e²) of the illuminating light beam 7 that enters the glass rod 16.

The illuminating light 7 that enters the glass rod 16 reaches the end facets 11a of the seven multi mode optical fibers 11 either directly or after being totally reflected at the interface between the outer peripheral surface of the glass rod 16 and the connector housing 13, and enters the optical fibers 11. The illuminating light beam 7 that enters the multi mode optical fibers 11 propagates therethrough, is output from the end facets at the second end portion, and enters the 49 multi mode optical fibers 21. The illuminating light beam 7 that enters the multi mode optical fibers 21 propagates therethrough, is output from the second end facets 21a, and illuminates an observed portion within a human body cavity or the like.

In the light guide for endoscopes 10 according to the first embodiment, the outer diameter of the glass rod 16 is equal to or greater than the focused spot diameter of the illuminating light beam 7, as described above. Therefore, heat is not generated at optical fibers outside a focused region of the illuminating light beam 7, unlike in conventional light guides, in which optical fibers are positioned outside the focused spot diameter. In addition, the illuminating light beam 7 does not heat the multi mode optical fibers 11 outside the focused range thereof at the portion at which the glass rod 16 and the multi mode optical fibers 11. Accordingly, heat generation at the connection portion is also prevented.

In addition, the seven multi mode optical fibers 11 are connected to the glass rod 16 in the maximally densely packed state, as illustrated in FIG. 2. Therefore, heat generation due to the illuminating light beam being absorbed by the filling adhesive among the optical fibers 11 is significantly reduced. As a specific example, in the conventional light guide illustrated in FIG. 7, the amount of heat generated at the filling adhesive 12 among optical fibers 11 reaches approximately 30% of the output of the illuminating light source 6. In contrast, in the light guide of the first embodiment, the amount of heat generated at the filling adhesive 12 among optical fibers 11 can be suppressed to approximately 10% of the output of the illuminating light source 6.

Note that the portion of the light guide for endoscopes 10 close to the light output end thereof is flexed by operations of an external mechanism (not shown). In the light guide for endoscopes 10 of the first embodiment, the light output end is constituted by the comparatively small diameter multi mode optical fibers 21. Therefore, flexing operations are enabled at smaller radii of curvature. Specifically, the minimum radius of curvature at the portion of the light guide for endoscopes 10 of the first embodiment at which the plurality of multi mode optical fibers 21 are bundled is approximately 5 mm. On the other hand, the base portion of the light guide for endoscopes 10, at which flexibility is not required, is constituted by the comparatively large diameter multi mode optical fibers 11, thereby improving the durability thereof. Note that the minimum radius of curvature at the portion where the multi mode optical fibers 11 are bundled is approximately 50 mm.

Further, in the light guide for endoscopes 10 according to the first embodiment, the concave transparent member 21 is provided in close contact with the end facets 21a of the multi mode optical fibers 21. Therefore, the illuminating light beam 7 which is output from the end facets 21a is diffused by the effect of the concave shape of the transparent member 21. Accordingly, an advantageous effect that the illuminated range can become even wider is obtained.

Next, a second embodiment of the present invention will be described. FIG. 4 is a side view that illustrates a light guide for endoscopes 30 according to a second embodiment of the present invention. The light guide for endoscopes 30 differs from the light guide for endoscopes 10 of FIG. 1 in that the light output portion of the plurality of multi mode optical fibers 21 is of a tapered shape. Note that in FIG. 4, elements which are the same as those illustrated in FIG. 1 are denoted with the same reference numerals, and detailed descriptions thereof will be omitted insofar as they are not particularly necessary (the same applies to all subsequent embodiments).

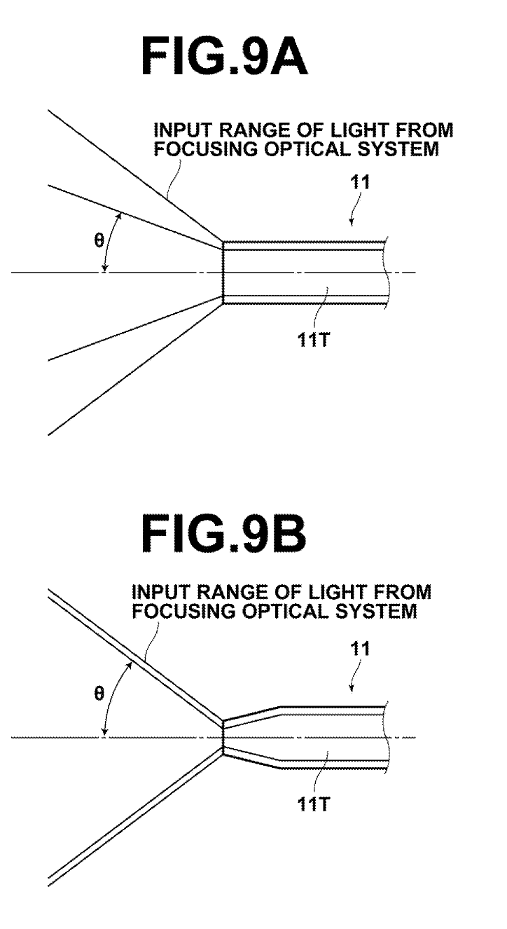

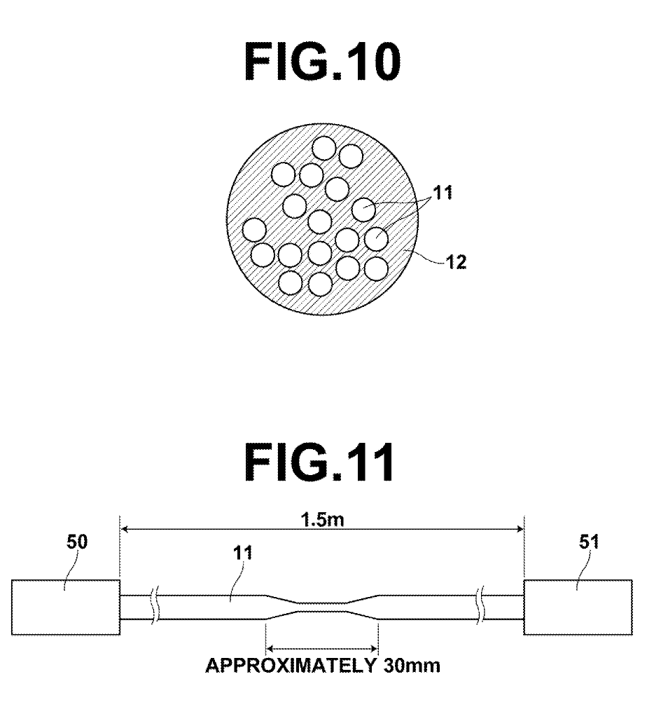

A wider range of the observed portion can be illuminated by the light output portion of the plurality of multi mode optical fibers 21 being formed as tapered shapes. The reason why this advantageous effect is obtained is as explained previously with reference to FIG. 9.

In the light guide for endoscopes 30 of the second embodiment as well, the portion in the vicinity of the light output end thereof is constituted by the comparatively small diameter multi mode optical fibers 21. Therefore, this portion can be flexed at smaller radii of curvature. On the other hand, the base portion of the light guide for endoscopes 30, at which flexibility is not required, is constituted by the comparatively large diameter multi mode optical fibers 11, thereby improving the durability thereof.

Further, the glass rod 16 is utilized at the light input portion of the light guide for endoscopes 30 in a similar manner to the light guide for endoscopes 10 of the first embodiment. Accordingly, the same advantageous effects which are obtained by the light guide for endoscopes 10 of the first embodiment are also obtained by the light guide for endoscopes 30 of the second embodiment.

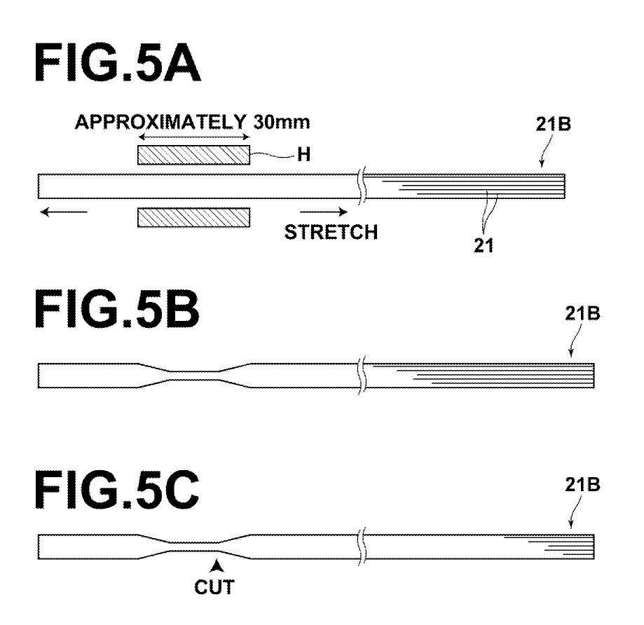

Next, a method for forming the light output portions of the plurality of multi mode optical fibers 21 into the tapered shape will be described with reference to FIGS. 5A, 5B, and 5C. First, a bundle 21B, which is an assembly of a plurality of multi mode optical fibers 21, is prepared. A portion thereof is heated to 500° C. or greater, for example, by a heater H having a heating length of approximately 30 mm, and the heated portion is stretched and elongated (FIG. 5A). Thereby, the heated and stretched portion of the bundle 11B becomes tapered (FIG. 5B). Next, the bundle 21B is cut at the tapered portion (FIG. 5C). Thereby, the light output portion of the plurality of multi mode optical fibers 21B can be processed into the tapered shape described above.

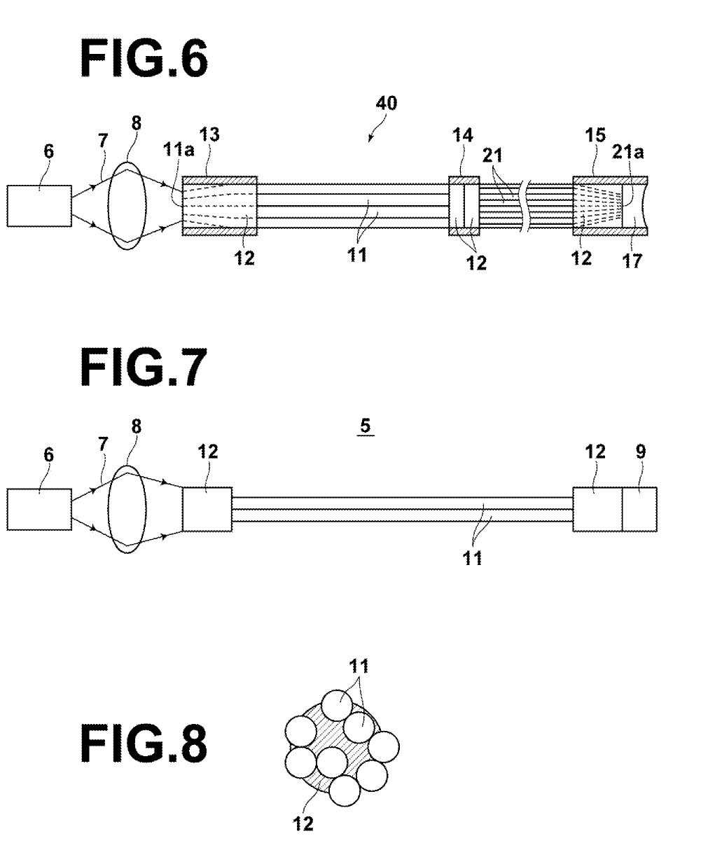

Next, a third embodiment of the present invention will be described. FIG. 6 is a side view that illustrates a light guide for endoscopes 40 according to a third embodiment of the present invention. The light guide for endoscopes 40 differs from the light guide for endoscopes 30 illustrated in FIG. 4 in that the glass rod 16 is omitted, and the light input portion of the multi mode optical fibers 11 is of a tapered shape in a manner similar to the light output portion of the plurality of multi mode optical fibers 21. Note that the method described previously with reference to FIG. 5 may be applied to form the light input portion of the multi mode optical fibers 11 into the tapered shape.

In the light guide for endoscopes 40 of the third embodiment as well, the portion in the vicinity of the light output end thereof is constituted by the comparatively small diameter multi mode optical fibers 21. Therefore, this portion can be flexed at smaller radii of curvature. On the other hand, the base portion of the light guide for endoscopes 40, at which flexibility is not required, is constituted by the comparatively large diameter multi mode optical fibers 11, thereby improving the durability thereof.

In addition, in the light guide for endoscopes 40 of the third embodiment, the first end portion of the multi mode optical fibers 11, which is the light input portion where the illuminating light beam 7 enters, and the second end portion of the multi mode optical fibers 21, which is the light output portion where the illuminating light beam 7 is output, are both of tapered shapes. Therefore, the illuminating light beam enters the light input portion at a high utilization efficiency, and a wider range of the observed portion can be illuminated by the light output portion. The reasons why these advantageous effects are obtained are as explained previously with reference to FIG. 9.

Further, in the light guide 40 for endoscopes according to the third embodiment, the first end portion of the multi mode optical fibers 11, which is the light input portion where the illuminating light beam 7 enters, and the second end portion of the multi mode optical fibers 21, which is the light output portion where the illuminating light beam 7 is output, are both of tapered shapes. Therefore, the plurality of multi mode optical fibers 11 and the plurality of multi mode optical fibers 21 become a maximally densely packed structure or approach a maximally densely packed structure, and the filling adhesive 12 is not present among the optical fibers, or only a small amount of the filling adhesive 12 is present among the optical fibers. Therefore, the end portions becoming prone to damage due to deterioration of the filling adhesive 12 can be positively prevented.

Next, favorable examples of the aforementioned tapered shapes will be described. As illustrated in FIG. 11, a first end portion of a multi mode optical fiber 11 having an outer diameter of 125 μm and a length of 1.5 m was connected to a laser light emitting system 50, and a second end portion thereof was connected to a photodetector 51, to produce an evaluating system. The central portion of the multi mode optical fiber 11 was heated across a range of 30 mm and stretched, to form a tapered portion. Five evaluating systems were produced, with stretched lengths of 0 mm (zero, no extension), 1 mm, 3 mm, 6 mm, and 8 mm.

Evaluations were performed as follows. Laser beams having a wavelength of 633 nm were emitted from the laser light emitting system 40 of each evaluating system, and caused to enter the multi mode optical fibers 11 to propagate therethrough. The intensities of the laser beams which were output from each of the multi mode optical fibers 11 were detected, to measure propagation loss in each of the optical fibers 11. The results are shown in Table 1 below. Note that in Table 1, the “Fiber Diameter” refers to the cladding diameter of the thinnest portion due to the tapering of each optical fiber. In addition, the “Tapering Rate” is defined as (cladding diameter which has been decreased by tapering)/(cladding diameter prior to tapering=125 μm). Generally, the ratio of core diameters with respect to cladding diameters of optical fibers is approximately 0.84. This ratio applies to each of the optical fibers in the evaluating systems. Therefore, the tapering rate represents the tapering rate of the core diameters.

TABLE 1

| Extension | Fiber Diameter | Tapering Rate | Loss |
|---|---|---|---|
| (mm) | (μm) | (%) | (%) |
| 0 | 125 | 0 | 0 |
| 1 | 110 | 12 | 1 |
| 3 | 100 | 20 | 2 |
| 6 | 80 | 36 | 2 |
| 9 | 50 | 40 | 3 |

As can be seen from the evaluation results of Table 1, when the tapering rate is 36%, the amount of loss is 2%. However, when the tapering rate increases above 36%, there is a possibility that the amount of loss will increase to 3%. Generally, 0.1 dB to 0.5 dB (2.3% to 10.9%) is the range of allowable amounts of loss for connectors that connect optical fibers. Therefore, it is desirable to suppress the amount of loss at the tapered portions to be 2% or less. Accordingly, it is preferable for the tapering rate of the light input portion of the light guide for endoscope of the present invention to be less than 36%. On the other hand, it is desired to increase the area illuminated by the illuminating light beam as much as possible at the light output portion. Therefore, the tapering rate of the light output portion is not limited to the aforementioned value, and may be set greater than 36%.

What is claimed is:

1. A light guide for endoscopes constituted by a plurality of bundled optical fibers, for propagating an illuminating light beam that enters from a light input end facet thereof to a light output end facet thereof, to emit the illuminating light beam onto a portion to be observed; the light guide comprising:
a plurality of comparatively large diameter optical fibers; and
a plurality of comparatively small diameter optical fibers which are provided at the side of the light guide toward the light output end facet thereof;
each of the comparatively large diameter optical fibers being connected to a plurality of the comparatively small diameter optical fibers.

2. A light guide for endoscopes as defined in claim 1, wherein:
the plurality of comparatively small diameter optical fibers are connected to each of the comparatively large diameter optical fibers in a maximally densely packed state.

3. A light guide for endoscopes as defined in claim 2, wherein:
a central optical fiber and six peripheral optical fibers which are arranged about the periphery of the central optical fiber are employed as the comparatively small diameter optical fibers; and
the optical fibers form the maximally densely packed state by being provided such that each of the six peripheral optical fibers is in contact with the central optical fiber, and adjacent peripheral optical fibers are in contact with each other.

4. A light guide for endoscopes as defined in claim 1, further comprising:
a transparent member having a sectional shape which is at least as large as the focused spot of the illuminating light beam, provided in close contact with the light input end facets of the comparatively large diameter optical fibers; and wherein
the comparatively large optical fibers are in contact with the transparent member in a maximally densely packed state.

5. A light guide for endoscopes as defined in claim 2, further comprising:
a transparent member having a sectional shape which is at least as large as the focused spot of the illuminating light beam, provided in close contact with the light input end facets of the comparatively large diameter optical fibers; and wherein
the comparatively large optical fibers are in contact with the transparent member in a maximally densely packed state.

6. A light guide for endoscopes as defined in claim 3, further comprising:
a transparent member having a sectional shape which is at least as large as the focused spot of the illuminating light beam, provided in close contact with the light input end facets of the comparatively large diameter optical fibers; and wherein
the comparatively large optical fibers are in contact with the transparent member in a maximally densely packed state.

7. A light guide for endoscopes as defined in claim 4, wherein:
the transparent member is constituted by a glass rod.

8. A light guide for endoscopes as defined in claim 5, wherein:
the transparent member is constituted by a glass rod.

9. A light guide for endoscopes as defined in claim 6, wherein:
the transparent member is constituted by a glass rod.

10. Alight guide for endoscopes as defined in claim 4, wherein:
a central optical fiber and six peripheral optical fibers which are arranged about the periphery of the central optical fiber are employed as the optical fibers which are connected to the transparent member; and
the optical fibers form the maximally densely packed state by being provided such that each of the six peripheral optical fibers is in contact with the central optical fiber, and adjacent peripheral optical fibers are in contact with each other.

11. Alight guide for endoscopes as defined in claim 7, wherein:
a central optical fiber and six peripheral optical fibers which are arranged about the periphery of the central optical fiber are employed as the optical fibers which are connected to the transparent member; and
the optical fibers form the maximally densely packed state by being provided such that each of the six peripheral optical fibers is in contact with the central optical fiber, and adjacent peripheral optical fibers are in contact with each other.

12. Alight guide for endoscopes as defined in claim 1, wherein:
multi mode optical fibers are employed as the optical fibers; and
at least one of a light input portion, at which the illuminating light enters the optical fibers, and the light output portion, from which the illuminating light is output, are of a tapered shape, while the number of multi mode optical fibers at the light input portion and the number of multi mode optical fibers at the light output portion are the same as that at other portions of the light guide.

13. Alight guide for endoscopes as defined in claim 2, wherein:
multi mode optical fibers are employed as the optical fibers; and
at least one of a light input portion, at which the illuminating light enters the optical fibers, and the light output portion, from which the illuminating light is output, are of a tapered shape, while the number of multi mode optical fibers at the light input portion and the number of multi mode optical fibers at the light output portion are the same as that at other portions of the light guide.

14. Alight guide for endoscopes as defined in claim 3, wherein:
multi mode optical fibers are employed as the optical fibers; and
at least one of a light input portion, at which the illuminating light enters the optical fibers, and the light output portion, from which the illuminating light is output, are of a tapered shape, while the number of multi mode optical fibers at the light input portion and the number of multi mode optical fibers at the light output portion are the same as that at other portions of the light guide.

15. A light guide for endoscopes as defined in claim 4, wherein:
multi mode optical fibers are employed as the optical fibers; and
at least one of a light input portion, at which the illuminating light enters the optical fibers, and the light output portion, from which the illuminating light is output, are of a tapered shape, while the number of multi mode optical fibers at the light input portion and the number of multi mode optical fibers at the light output portion are the same as that at other portions of the light guide.

16. A light guide for endoscopes as defined in claim 1, further comprising:
a concave transparent member, which is provided in close contact with the light output end facet.

17. A light guide for endoscopes as defined in claim 2, further comprising:
a concave transparent member, which is provided in close contact with the light output end facet.

18. A light guide for endoscopes as defined in claim 3, further comprising:
a concave transparent member, which is provided in close contact with the light output end facet.

19. A light guide for endoscopes as defined in claim 4, further comprising:
a concave transparent member, which is provided in close contact with the light output end facet.
